(19) United States
(12) Patent Application Publication
(10) Pub. No.: US 2005/0191443 A1
(43) Pub. Date: Sep. 1, 2005

(54) Ink jet recording sheet

(76) Inventors: Hirokazu Sunagawa, Tokyo (JP); Satoshi Matsuura, Chiba-shi (JP); Rie Teshima, Tokyo (JP); Kazuo Totani, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/058,026

(22) Filed: Feb. 15, 2005

(30) Foreign Application Priority Data
Feb. 18, 2004 (JP) 2004-041981

(51) Int. Cl. B41M 5/00

(52) U.S. Cl. 428/32.29

(57) ABSTRACT

Ink jet recording sheet has excellent recording properties and print preservability (especially, print light resistance and ozone resistance) for dye ink as well as pigment ink. The ink jet recording sheet includes: a supporting medium; and an ink receiving layer disposed on the supporting medium, the ink receiving layer including pigment, at least a styrene-acryl copolymer resin as an adhesive, and a guanidine compound and a secondary ammonium salt compound as a cationic polymer.

Priority is claimed on Japanese Patent Application No. 2004-041981, filed Feb. 18, 2004, the content of which is incorporated herein by reference.

### BACKGROUND OF THE INVENTION

1. Field of the Invention

The present invention relates to ink jet recording sheet and printed matter using the ink jet recording sheet.

2. Description of Related Art

Ink jet recording systems in which aqueous ink is ejected through a nozzle having fine pores to form an image on a recording medium is widely used in terminal printers, facsimiles, plotters, sheet feeding printers, etc., due to low noise during recording, ease of performing color recording, possibility of performing high-speed recording, lower cost than other printing devices, and so forth.

Recently, demand has rapidly increased for printouts produced by using ink jet recording system to be utilized as media having excellent design characteristics, such as large posters, displays and leaflets. It is known that aqueous ink is generally used for a printer which is employed for producing such printouts.

The aqueous ink may be categorized into dye ink which includes dye and pigment ink which includes pigment, and the dye ink is mainly used due to its clearness. However, since the dye ink is often used for large posters displayed outside recently, disadvantages of the dye ink have become conspicuous in that it is easily oxidized by ultraviolet rays, ozone, etc., during long term exhibition to cause discoloration and deterioration in appearance of the image, and a sufficient light resistance of the printed image cannot be obtained.

On the other hand, although the pigment ink has an advantageous characteristic that it has excellent light resistance of the printed image, there is a problem in that a clear printed image cannot be obtained using a conventional ink jet recording sheet for dye ink since the particle size of the pigment ink is significantly larger than that of the dye ink. Also, the pigment ink has another drawback in that it has low water-resistance and ink will be spread when water is attached to the surface of a recorded image.

For the reasons described above, although both the ink jet recording sheet for dye ink and the ink jet sheet for pigment ink have been developed, demand for an ink jet recording sheet having excellent printability for both dye ink and pigment ink have increased.

As a method for obtaining an ink jet recording sheet which exhibits excellent ink jet suitability when printed on using dye ink as well as pigment ink, various methods have been proposed, such as a method in which a water soluble metal salt is included in a coating solution (for example, refer to Japanese Laid-open Patent Application No. 2002-274022), a method in which two or more coating layers are formed (for example, refer to Japanese Laid-open Patent Application No. 2000-94831, Japanese Laid-open Patent Application No. 2000-168228, Japanese Laid-open Patent Application No. 2002-347330, and Japanese Laid-open Patent Application No. Hei 10-278411), a method in which the surface of a coating layer is controlled to have a specific roughness (for example, refer to Japanese Laid-open Patent Application No. 2000-158804), a method in which pigment having a specific particle size is included in a coating layer (for example, refer to Japanese Laid-open Patent Application No. 2001-270238), and a method in which a coating layer made of a porous organic resin having a specific pore diameter, pore volume, and pH range, is used (for example, refer to Japanese Laid-open Patent Application No. 2001-246841).

However, none of the ink jet recording sheets described in the above patent documents have both excellent coloring property and printing preservability (especially, light resistance and ozone-resistance), and ink jet recording sheet capable of obtaining both the excellent coloring property and print preservability using both the dye ink and the pigment ink is currently not available.

### SUMMARY OF THE INVENTION

The present invention has been achieved in consideration of the above situation, and an object of the present invention includes to provide an ink jet recording sheet having excellent recording properties and print preservability (especially light resistance and ozone-resistance) for both the dye ink and pigment ink.

That is, the ink jet recording sheet of the present invention includes the following aspects:

(1) Ink jet recording sheet, including: a supporting medium; and an ink receiving layer disposed on the supporting medium, the ink receiving layer including: pigment; at least a styrene-acryl copolymer resin as an adhesive; and a guanidine compound and a secondary ammonium salt compound as a cationic polymer.

(2) The ink jet recording sheet according to (1) above, wherein at least a part of the pigment has a surface treated with a surfactant.

(3) The ink jet recording sheet according to (2) above, wherein the pigment is silica.

(4) The ink jet recording sheet according to (1) above, wherein a glass transition temperature of the styrene-acryl copolymer resin is within a range of −10 to 60° C.

(5) The ink jet recording sheet according to (1) above, wherein the guanidine compound is a dicyandiamide-polyethylene amine copolymer.

(6) The ink jet recording sheet according to (1) above, wherein the secondary ammonium salt compound is a compound having an acrylamide-diallyl amine structure.

(7) Ink jet recording sheet, including: a supporting medium; and an ink receiving layer disposed on the supporting medium, the ink receiving layer including; pigment; at least a styrene-acryl copolymer resin as an adhesive; and a dicyandiamide-polyethylene amine copolymer and a compound having an acrylamide-diallyl amine structure as a cationic polymer.

(8) Printed matter including the ink jet recording sheet according to any one of (1) to (7) above, which is printed using dye ink.

(9) Printed matter including the ink jet recording sheet according to any one of (1) to (7) above, which is printed using pigment ink.

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementation of the invention, is not intended to limit the enumerated claims, but to serve as particular examples thereof.

Hereinafter, the present invention will be explained in detail.

(Layer Structure)

The present invention provides an ink jet recording sheet in which at least a styrene-acryl copolymer resin is disposed on a supporting medium as an adhesive, and an ink receiving layer which includes, as a cationic polymer, a guanidine compound and a secondary ammonium salt compound is disposed on the supporting medium.

Note that, according to the present invention, the ink receiving layer may be provided on both sides of the supporting medium. In such a case, it becomes possible to provide a clear print image on both sides of the ink jet recording sheet. Also, the ink receiving layer may be formed by a plurality of layers.

(Supporting Medium)

The supporting medium is not particularly limited as long as it is a medium which can be used for ordinary ink jet recording paper. Examples thereof includes papers, such as woodfree paper, art paper, coated paper, cast-coated paper, foil paper, craft paper, baryta paper, impregnated paper, and vapor deposition paper; resin films, nonwoven fabrics, and resin-coated paper, such as one in which a resin film is attached to coated paper or woodfree paper via an adhesive, and one in which a resin is laminated on paper.

(Adhesive)

A styrene-acryl copolymer resin is used as an adhesive which is included in the ink receiving layer. Although an emulsion type adhesive and a water soluble adhesive, besides the styrene-acryl copolymer resin, is generally known as an adhesive, the inventors of the present invention have found after diligent studies that a clear print image is obtained when a styrene-acryl copolymer resin is used. The mechanism of how the styrene-acryl copolymer resin as an adhesive contributes to obtaining a clear print image is not clear; however, it may be attributed to the compatibility between the ink jet recording sheet and the dye ink or the pigment ink. That is, a styrene-acryl copolymer resin is often added to ink in order to improve dispersibility, viscosity adjustment, preservability, and so forth although the exact reasons why such improvements can be achieved are not known. Speculating from that, for the case where a styrene-acryl copolymer resin is included in the ink receiving layer of the ink jet recording sheet, it is considered that the compatibility, wettablity, etc., are also improved and a clear image is obtained.

The styrene-acryl copolymer resin used in the present invention may be obtained by copolymerizing at least one selected from the group consisting of styrene and a-methyl styrene with various functional group-including monomers, for example, alkyl (meth)acrylate, such as methyl(meth)acrylate, ethyl(meth)acrylate, butyl(meth)acrylate, 2-ethylhexyl(meth)acrylate, and stearyl(meth)acrylate; as hydrophilic monomers, a carboxyl group including monomer, such as acrylic acid and methacrylic acid; a hydroxyl group including monomer, such as hydroxyethyl(meth)acrylate; an alkylene glycol group including monomer, such as (poly)ethylene glycol (meth)acrylate; an amino group including monomer, such as dimethyl aminoethyl (meth)acrylate; and an N-alkyl substituted acrylamide, such as glycysil (meth)acrylate, (meth)acrylamide, and N-methyl(meth)acrylamide. Among these hydrophilic monomers, nonionic and cationic monomers may be suitably used from the viewpoints of preparing an ink receiving layer coating and of the compatibility with ink dye. Also, if necessary, it is possible to copolymerize cross-linking monomers having two or more polymerizable double bonds, such as divinylbenzene and (poly)ethylene glycol di(meth)acrylate.

The polymerization reaction may be achieved by using a normal method, such as an emulsion polymerization and a solution polymerization. Among these methods, the emulsion polymerization is preferably used from the viewpoints of ease in polymerization control, handling and so forth. The emulsion polymerization may be conventionally carried out by emulsifying monomers by using a surfactant, etc., and employing salt of persulfate, such as ammonium persulfate and potassium persulfate, azo compounds such as azo-bis-isobutylnitrile, and peroxides, such as benzoyl peroxide, as an initiator.

As the surfactant, nonionic surfactants, such as polyoxyethylenealkyl ether, polyoxyethylenealkyl ester, and polyoxyethylenesorbitanalkyl ester; anionic surfactants, such as sulfate, fatty acid soap, and higher alcohol alkyl sulfate of the above nonionic surfactant; cationic surfactants, such as lauryl amine hydrochloride and alkylbenzyldialkylammonium hydrochloride; and ampholytic surfactant may be used in a suitable combination. For the case in which a nonionic monomer or a cationic monomer is used as a hydrophilic monomer, it is preferable, among the above-mentioned surfactants, to use a cationic surfactant and/or a nonionic surfactant. From the viewpoint of preparing an ink receiving layer coating, it is also preferable to use a cationic surfactant and/or a nonionic surfactant.

The glass transition temperature of the styrene-acryl copolymer resin used in the present invention may be adjusted by changing the polymerization ratio of the above-mentioned various monomers, and it is generally adjusted to be within the temperature range of −10 to 60° C. by taking into account the coloring and adhesive characteristics, and so forth. The degree of polymerization may be adjusted by utilizing a known chain transfer agent, such as alkyl mercaptan, mercapto acetic acid, and mercapto ethanol.

Although various methods may be used for polymerization, such as a batch loading method, a partial addition method, and a gradual (or continuous) addition method, the gradual addition method of monomer is preferable from the viewpoint of readiness in controlling the reaction. Also, the gradual addition may be carried out for monomer emulsion, and it is possible to gradually add an initiator at the same time in the reaction.

As an adhesive used in the ink receiving layer, it is possible to use, together with the styrene-acryl copolymer resin, proteins, such as casein, soy bean protein, and synthesized protein; various starches, such as ordinary starch and oxidized starch; polyvinyl alcohol and derivatives thereof; cellulose derivatives, such as carboxymethyl cellulose and methyl cellulose; acryl resins which are polymers or copolymers of acrylic acid, methacrylic acid, acrylate, methacrylate, etc.; and conventionally known adhesives for ink jet recording, for example, vinyl resins, such as ethylene-vinylacetate copolymer.

As an adhesive which may be used together with the styrene-acryl copolymer resin, polyvinyl alcohol is preferable among the above adhesives due to its excellent adhesiveness with pigment. Polyvinylalcohol derivatives, such as silanol denatured polyvinyl alcohol and cationized polyvinyl alcohol may also be suitably used.

When the styrene-acryl copolymer resin is used with polyvinyl alcohol or a derivative thereof, the ratio of these is preferably within the range of 1:10 to 2:1, and more preferably within the range of 1:5 to 1:1.

(Cationic Polymer)

According to the present invention, in order to fix the ink, a guanidine compound and a secondary ammonium salt compound are included as a cationic polymer. The coloring of both the dye ink and pigment ink, and the light resistance and the gas (mainly ozone gas) resistance of image are improved by using the guanidine compound together with the secondary ammonium salt compound although the particular reasons of the improvements are not yet known. If one of the guanidine compound and the secondary ammonium salt compound is not used, these superior effects cannot be obtained.

From the viewpoint of coloring and preservability of image, it is preferable to use a dicyandiamide (also called cyanoguanidine)-polyethyleneamine copolymer as the guanidine compound together with a compound having an acrylamide-diallyl amine structure as the secondary ammonium salt compound.

According to the present invention, it is possible to use known cationic polymer, other than the guanidine compound and the secondary ammonium salt compound, as long as it does not deteriorate the effect of the guanidine compound and of the secondary ammonium salt compound. Examples of the known cationic polymer include: 1) polyalkylene polyamines or derivatives thereof, such as polyethylene amine and polypropylene polyamine; 2) acryl resins having a tertiary amine group and/or a quaternary ammonium group; 3) polyvinyl amine, polyvinyl amidine, and 5-member ring amidines; 4) dicyan (cyanogen) cationic resins, represented by dicyandiamide-formalin polycondensation products; 5) polyamine cationic resins, represented by dicyandiamide-diethylenetriamine polycondensation products; 6) dimethylamine-epochlorhydrin addition polymerization products; 7) diallydimethylammonium chloride-SO₂ copolymer; 8) dimethyldiallylammonium chloride polymer; 9) polymer of allyl amine salt; 10) dialkylaminoethyl(meth)acrylate quaternary salt polymer; and 11) aluminum salts, such as aluminum polychloride, aluminum polyacetate, and aluminum polylactate, which are commercially available.

The amount of the cationic polymer is adjusted to be 5 to 60% by weight, preferably 20 to 50% by weight, with respect to 100% by weight of pigment. If the amount of the cationic polymer is too small, coloring of image and the preservability of image will be deteriorated. If the amount of the cationic polymer is too large, on the other hand, the ink absorptivity and the clearness of image will be deteriorated and uneven color will be caused.

(Pigment)

According to the present invention, the pigment used for the ink receiving layer is not particularly limited as long as it is conventionally used for a coating layer or ink receiving layer of ink jet recording paper. Examples of the pigment include inorganic pigments, such as silica, soft calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, aluminum hydroxide, alumina, pseudoboehmite, lithopone, zeolite, hydrated halloysite, magnesium carbonate, and magnesium hydroxide; and organic pigments made of resins, such as an acryl or methacryl resin, a vinyl chloride resin, a vinyl acetate resin, a polyester resin, a styrene-acryl resin, a styrene-butadiene resin, a styrene-isoprene resin, a polycarbonate resin, a silicone resin, a urea resin, a melamine resin, an epoxy resin, a phenol resin, and a diallylphthalate resin. These resins may be in a spherical form or in an amorphous form, and may be porous or non-porous. Also, these pigments may be used singularly or in a combination of two or more.

Among these pigments, it is preferable to use silica, alumina, pseudoboehmite, soft calcium carbonate, and zeolite due to their excellent coloring and ink absorbing properties. Among them, it is more preferable to use silica, alumina, and pseudoboehmite, and it is most preferable to use silica.

As for the above-mentioned silica, use of amorphous silica is preferable. Methods for producing the silica is not particularly limited, and it may be produced by using an arc method, a dry method, a wet method (precipitation method, gel method), and so forth. Among these methods, the wet method is preferable since the silica produced by the method is suitable for the ink jet recording sheet for pigment ink as well as the ink jet recording sheet for dye ink.

When wet type silica is used, the average particle size of the secondary particle of the wet silica is preferably 2 to 12 μm, and more preferably 4 to 10 μm. If the average particle size is less than 2 μm, the absorptivity for dye ink of the ink jet recording sheet which includes such silica will be reduced. Also, since the light transmittance thereof will increase, light resistance of the image formed by dye ink as well as the coating strength will be reduced. Also, when this is used for ink jet recording sheet for pigment ink, disadvantages such as lowering in the fixation property of the pigment ink will be caused. If the average particle size of the secondary particle of the wet silica exceeds 12 μm, on the other hand, problems will be caused for the ink jet recording sheet for dye ink as well as the ink jet recording sheet for pigment ink, such as lowering in clearness of image and the generation of blur of image due to surface roughness.

Note that the term “average particle size of silica” in this application is measured by using a call counter method, and it indicates a volume average particle size measured by using a sample of silica which is ultrasonically dispersed in distilled water for 30 seconds.

According to the present invention, it is preferable that the surface of at least a part of the pigment contained in the ink receiving layer be treated with a surfactant. That is, the surface of all of the pigment may be treated with a surfactant, or it is possible to use the surface treated pigment together with untreated pigment. The untreated pigment is the same as those explained above, and hence the explanation thereof will be omitted.

(Pigment whose Surface is Treated with Surfactant)

As the pigment whose surface is treated with a surfactant, it is possible to use the same pigments as described above, and it is preferable to use silica, alumina, pseudoboehmite, soft calcium carbonate, and zeolite. Among them, it is more preferable to use silica, alumina, and pseudoboehmite, and it is most preferable to use silica as described above.

Although the surfactant used for treating the surface of the pigment is not particularly limited as described for those mentioned above, it is preferable to use nonionic surfactant. Examples of the nonionic surfactant include polyoxyethylenealkyl ether, polyoxyethylenepolyoxypropylene copolymer, and polyoxyethylenepolyoxypropylenealkyl ether. Among these, one having a hydrophile-lipophile balance (HLB) value of 8.0 to 15.0 is preferable, and one having HLB value of 10.0 to 12.0 is more preferable.

As a method for treating the surface of pigment using a surfactant, one which is described in, for example, Japanese Laid-Open Patent Application No. Hei 9-25440 may be adopted. That is, a dry mixing method may be adopted in which pigment, for example, wet type silica, and a surfactant, for example, polychain type nonionic surfactant, are mixed using a mixer, such as a high-speed stream mixer. In such a case, it is possible to add a surfactant directly to pigment, and it is also possible to add a surfactant which is diluted with a volatile solvent, such as ethanol, to pigment and mix these.

Moreover, it is possible to adopt a wet treatment method in which a predetermined amount of a surfactant, for example, a nonionic surfactant is added and mixed with an emulsion slurry solution of pigment, for example, wet type silica, and a spray-drying process is subsequently carried out. In the wet treatment method, if the surfactant is insoluble with water, it is preferable to strongly disperse the surfactant in water to form an emulsion in advance, sequentially add the emulsion to an emulsified slurry solution of pigment to be sufficiently mixed, and then carry out a drying process.

The surface of the silica which is treated by a surfactant using the method described above is considered to be covered by the surfactant.

The amount of surfactant added is preferably 0.1 to 30 parts, more preferably 0.5 to 20 parts, with respect to 100 parts of pigment. When silica which is covered by the surfactant within the above-mentioned range is included, it becomes possible to improve the coloring property and to obtain a clear image.

It is possible to add various auxiliary agents, which are generally used for producing coated paper, in a suitable amount, to the ink receiving layer, such as a thickener, an antifoamer, a wetting agent, a surfactant, a coloring agent, an antistatic agent, a light resistance auxiliary agent, an UV absorber, an antioxidizing agent, and an antiseptic agent.

The above-mentioned ink receiving layer may be obtained by applying an ink receiving layer coating solution which includes the above-mentioned silica, adhesive, cationic polymer, and auxiliary agent, if necessary, to one or both surfaces of a supporting medium, and drying the solution.

Although the coating amount of the ink receiving layer is not particularly limited, it is preferably 2 to 30 g/m², and more preferably 5 to 20 g/cm², for one surface.

If the coating amount is less than the above-mentioned lower limit, the ink absorbing property, the clearness of image, and the image preservability tend to be deteriorated. If the coating amount is larger than the above-mentioned upper limit, the coating strength and the clearness of image tend to be decreased.

Note that the ink receiving layer may be formed by a plurality of layers as described above, and in such a case, the composition of each of the ink receiving layers may be the same or different from each other.

The ink receiving layer may be formed by using various known application devices, such as a blade coater, an air knife coater, a roll coater, a bar coater, a gravure coater, a rod blade coater, a lip coater, a curtain coater, and a die coater. It is possible to carry out a finishing process using a calender device, such as a machine calender, a super calender, and a soft calender.

(Printed Matter)

Printed matter may be produced by printing the ink jet recording sheet explained above with dye ink or pigment ink using a printing device, such as a printer.

According to the present invention, excellent coloring property and sufficient image concentration are obtained by using dye ink as well as pigment ink, and excellent image clearness may be attained. Moreover, printed matter whose preservability (especially, light resistance and ozone resistance) of images is excellent for dye ink as well as pigment ink is obtained, and the printed matter may be displayed outside and exhibited in various places.

### EXAMPLES

Hereinafter, the present invention will be explained in detail with reference to Examples. However, it is apparent that the present invention is not limited to these Examples. Also, “parts” and “%” used in the examples indicate “parts by mass” and “% by mass” of a solid component excluding water unless otherwise so indicated.

Print concentration, print light resistance, and print ozone resistance of ink jet recording sheet which was obtained in each of Examples and Comparative Examples were evaluated using the methods described below.

Note that the evaluation was made by printing each of the ink jet recording sheet using commercially available ink jet printers A to C described below.

(Ink Jet Printer A)

A commercially available dye ink jet printer (a product of SEIKO EPSON Corporation, trade name: PM-G800; print mode: Fotomat paper/high fineness).

(Ink Jet Printer B)

A commercially available dye ink jet plotter (a product of SEIKO EPSON Corporation, trade name: PX-9000; ink: Mat black; print mode: PXMC premium mat paper/clean).

(Ink Jet Printer C)

A commercially available dye ink jet plotter (a product of Hewlett-Packard Co., trade name: Design Jet 5500; ink: pigment ink; print mode: best quality).

(Print Concentration)

Image issued by Japanese Standards Association (high fineness color digital standard image XYZ/JIS-SCID), Identification Number: S6; Image title: Color Chart) was printed using the above-mentioned three types of ink jet printers A to C, and the print concentration of the best black tone portion was measured using a measuring device of “RD-914”, a product of Guretag Macbeth Co.

(Print Light Resistance)

Printed matter which was printed using the above-mentioned ink jet printer A of dye ink type in which the discharge amount of magenta was adjusted to be 80% using a commercially available image processing software, was irradiated with a xenon lamp having illuminance of 100 klux under the condition of 65° C. and 40% RH for 72 hours and the print concentration thereof was measured. The light resistance of the printed portion was evaluated based on the standard described below using the following equation for calculating the remaining rate of the print concentration:
Print concentration remaining rate (%)=(print concentration after irradiation/print concentration before irradiation)×100
◯: remaining rate is 85% or higher;
Δ: remaining rate is 70% or higher and less than 85%; and
X: remaining rate is less than 70%.
   (Print Ozone Resistance)

Printed matter which was printed using the above-mentioned ink jet printer A of dye ink type in which the discharge amount of magenta was adjusted to be 80% using a commercially available image processing software, was left in an atmosphere of 2.5 ppm ozone concentration under the condition of 24° C. and 60% RH for 24 hours and the print concentration thereof was measured. The ozone resistance of the printed portion was evaluated based on the standard described below using the following equation for calculating the remaining rate of the print concentration:
Print concentration remaining rate (%)=(print concentration after being left/print concentration before being left)×100
◯: remaining rate is 85% or higher; and

Δ: remaining rate is 70% or higher and less than 85%.

### Example 1

(Preparation of Surface Treated Silica A)

Wet silica (900 g, a product of Tokuyama Corporation, product name: Finesil X-60) was suspended in water to obtain slurry (about 10 to 15%), and 100 g of a water-suspension of a surfactant (polyoxyethylenelauryl ether, product name: Noigen ET-102, a product of Dai-ichi Kogyo Seiyaku Co. Ltd., HLB: 10.8) was added to the slurry. The mixture was stirred for one hour, spray-dried, pulverized, and classified to obtain the surface treated silica A of the present invention. The average secondary particle size of the obtained surface treated silica A was 6 μm.

(Preparation of Styrene-Acryl Copolymer Resin A)

A copolymer having a ratio of styrene:2-ethylhexylacrylate:acrylamide=70:27: 3 was prepared in the following manner.

A mixture of 140 g of styrene and 54 g of 2-ethylhexylacrylate was added to water in which nonionic surfactant and 6 g of acrylamide had been dissolved, to obtain a monomer emulsion.

The same nonionic surfactant, which was used for the preparation of the monomer emulsion, and persulfate as an initiator were placed in a reaction flask, and the temperature thereof was increased to 80° C. About 10% of the monomer emulsion obtained as above was added to the flask, and after confirming that the reaction was initiated, the rest of 90% of the emulsion monomer was gradually added to the reaction mixture over three hours. After the completion of the addition, the above-mentioned temperature was maintained for 30 minutes. In this manner, a styrene-acryl copolymer emulsion having a concentration of 40% and a glass transition temperature Tg of 20° C. was obtained.

(Preparation of Ink Receiving Layer Coating Solution A)

An ink receiving layer coating solution A was prepared by mixing and dispersing 80 parts of wet silica (a product of Tokuyama Corporation, product name: Finesil X-60) as pigment, 20 parts of the surface treated silica A obtained as described above, 20 parts of silyl denatured PVA (a product of Kuraray Co. Ltd., product name: R-1130) and 20 parts of styrene-acryl copolymer resin A (having a glass transition temperature Tg of 20° C., and a ratio of styrene:2-ethylhexylacrylate:acrylamide=70:27:3) as an adhesive, 15 parts of dicyandiamide-polyethylene amine copolymer (a product of Nicca Chemical Co. Ltd., product name: Neofix IJ-117) and 15 parts of acrylamide-diallyl amine copolymer (a product of Sumitomo Chemical Co. Ltd., product name: SR1001) as a cationic polymer, and water.

(Preparation of Ink Jet Recording Sheet)

The ink receiving layer coating solution A was applied onto a surface of woodfree paper of 170 g/m² and dried to obtain an ink jet recording sheet.

Each of the above-mentioned evaluations was made for the ink jet recording sheet obtained. Results are shown in Table 1 below.

### Example 2

(Preparation of Styrene-Acryl Copolymer Resin B)

Styrene-acryl copolymer B was prepared in the same manner as in the preparation of styrene acryl copolymer A except that the ratio of styrene:2-ethylhexylacrylate:acrylamide was changed to be 85:12:3. The glass transition temperature Tg of the copolymer was 50° C.

(Preparation of Ink Receiving Layer Coating Solution B)

The ink receiving layer coating solution B was prepared in the same manner as described in Example 1 except that the styrene-acryl copolymer resin A in the ink receiving layer coating solution A was changed to the styrene-acryl copolymer B.

(Preparation of Ink Jet Recording Sheet)

Ink jet recording sheet was prepared in the same manner as described in Example 1 except that the ink receiving layer coating solution A was changed to the ink receiving layer coating solution B.

### Example 3

(Preparation of Ink Receiving Layer Coating Solution C)

The ink receiving layer coating solution C was prepared in the same manner as described in Example 1 except that the pigment in the ink receiving layer coating solution A was changed to 100 parts of wet silica (a product of Tokuyama Corporation, product name: Finesil X-60).

(Preparation of Ink Jet Recording Sheet)

Ink jet recording sheet was prepared in the same manner as described in Example 1 except that the ink receiving layer coating solution A was changed to the ink receiving layer coating solution C.

### Comparative Example 1

(Preparation of Ink Receiving Layer Coating Solution D)

The ink receiving layer coating solution D was prepared in the same manner as described in Example 3 except that the cationic polymer in the ink receiving layer coating solution C was changed to 30 parts of dicyandiamide-polyethylene amine copolymer (a product of Nicca Chemical Co. Ltd., product name: Neofix IJ-117).

(Preparation of Ink Jet Recording Sheet)

Ink jet recording sheet was prepared in the same manner as described in Example 3 except that the ink receiving layer coating solution C was changed to the ink receiving layer coating solution D.

### Comparative Example 2

(Preparation of Ink Receiving Layer Coating Solution E)

The ink receiving layer coating solution E was prepared in the same manner as described in Example 3 except that the cationic polymer in the ink receiving layer coating solution C was changed to 30 parts of acrylamide-diallyl amine copolymer (a product of Sumitomo Chemical Co. Ltd., product name: SR1001).

(Preparation of Ink Jet Recording Sheet)

Ink jet recording sheet was prepared in the same manner as described in Example 3 except that the ink receiving layer coating solution C was changed to the ink receiving layer coating solution E.

### Comparative Example 3

(Preparation of Ink Receiving Layer Coating Solution F)

The ink receiving layer coating solution F was prepared in the same manner as described in Example 3 except that the cationic polymer in the ink receiving layer coating solution C was changed to 15 parts of dicyandiamide-polyethylene amine copolymer (a product of Nicca Chemical Co. Ltd., product name: Neofix IJ-117) and 15 parts of polydiallyldimethylammonium chlroride (a product of Senka Co. Ltd., product name Unisense CP101).

(Preparation of Ink Jet Recording Sheet)

Ink jet recording sheet was prepared in the same manner as described in Example 3 except that the ink receiving layer coating solution C was changed to the ink receiving layer coating solution F.

### Comparative Example 4

(Preparation of Ink Receiving Layer Coating Solution G)

The ink receiving layer coating solution G was prepared in the same manner as described in Example 3 except that the cationic polymer in the ink receiving layer coating solution C was changed to 15 parts of acrylamide-diallyl amine copolymer (a product of Sumitomo Chemical Co. Ltd., product name: SR 1001) and 15 parts of polydiallyldimethylammonium chlroride (a product of Senka Co. Ltd., product name: Unisense CP101).

(Preparation of Ink Jet Recording Sheet)

Ink jet recording sheet was prepared in the same manner as described in Example 3 except that the ink receiving layer coating solution C was changed to the ink receiving layer coating solution G.

### Comparative Example 5

(Preparation of Ink Receiving Layer Coating Solution H)

The ink receiving layer coating solution H was prepared in the same manner as described in Example 3 except that the styrene-acryl copolymer resin A in the ink receiving layer coating solution C was changed to an acryl polymer (a product of Rohm and Haas Co. Ltd., product name: Primal P-376).

(Preparation of Ink Jet Recording Sheet)

Ink jet recording sheet was prepared in the same manner as described in Example 3 except that the ink receiving layer coating solution C was changed to the ink receiving layer coating solution H.

### Comparative Example 6

(Preparation of Ink Receiving Layer Coating Solution I)

The ink receiving layer coating solution I was prepared in the same manner as described in Example 3 except that the styrene-acryl copolymer resin A in the ink receiving layer coating solution C was changed to SBR (a product of JSR Co. Ltd., product name: 0589, Tg: 0° C., emulsion type adhesive).

(Preparation of Ink Jet Recording Sheet)

Ink jet recording sheet was prepared in the same manner as described in Example 3 except that the ink receiving layer coating solution C was changed to the ink receiving layer coating solution I.

### Comparative Example 7

(Preparation of Ink Receiving Layer Coating Solution J)

The ink receiving layer coating solution J was prepared in the same manner as described in Example 3 except that the styrene-acryl copolymer resin A in the ink receiving layer coating solution C was changed to an ethylene-vinylacetate copolymer (a product of Showa Hipolymer Co. Lid., product name: Polysol AM-3000, emulsion type adhesive).

(Preparation of Ink Jet Recording Sheet)

Ink jet recording sheet was prepared in the same manner as described in Example 3 except that the ink receiving layer coating solution C was changed to the ink receiving layer coating solution J.

### Comparative Example 8

(Preparation of Ink Receiving Layer Coating Solution k)

The ink receiving layer coating solution k was prepared in the same manner as described in Example 3 except that the styrene-acryl copolymer resin A in the ink receiving layer coating solution C was changed to a urethane resin (a product of Nicca Chemical Co. Ltd., product name: Evafanol HA-11, emulsion type adhesive).

(Preparation of Ink Jet Recording Sheet)

Ink jet recording sheet was prepared in the same manner as described in Example 3 except that the ink receiving layer coating solution C was changed to the ink receiving layer coating solution k.

In order to make clear the difference in ingredients of each of the above Examples and Comparative Examples, the contents of each are tabulated as follows.

| | | | | | Presence |
|---|---|---|---|---|---|
| | Cationic | Cationic | | | of surface |
| | resin 1 | resin 2 | Adhesive | Tg | treated silica |
| Ex. 1 | guanidine | secondary | styrene-acryl | 20° C. | present |
| Ex. 2 | guanidine | secondary | styrene-acryl | 50° C. | present |
| Ex. 3 | guanidine | secondary | styrene-acryl | 20° C. | absent |
| C. Ex. 1 | guanidine | none | styrene-acryl | 20° C. | absent |
| C. Ex. 2 | secondary | none | styrene-acryl | 20° C. | Absent |
| C. Ex. 3 | guanidine | quaternary | styrene-acryl | 20° C. | Absent |
| C. Ex. 4 | secondary | quaternary | styrene-acryl | 20° C. | Absent |
| C. Ex. 5 | guanidine | secondary | acryl | — | Absent |
| C. Ex. 6 | guanidine | secondary | SBR | — | Absent |
| C. Ex. 7 | guanidine | secondary | EVA | — | Absent |
| C. Ex. 8 | guanidine | secondary | urethane | — | Absent |

Results:

TABLE 1

| | | | | Print | Print |
|---|---|---|---|---|---|
| | Print concentration | | | light | ozone |
| | | Printer B | | resistance | resistance |
| | Printer A | (pigment | Printer C | Printer A | Printer A |
| | (dye ink) | ink) | (pigment ink) | (dye ink) | (dye ink) |
| Ex. 1 | 1.84 | 1.79 | 1.65 | ◯ | ◯ |
| Ex. 2 | 1.85 | 1.80 | 1.66 | ◯ | ◯ |
| Ex. 3 | 1.82 | 1.75 | 1.60 | ◯ | ◯ |
| C. Ex. 1 | 1.74 | 1.76 | 1.62 | X | ◯ |
| C. Ex. 2 | 1.83 | 1.69 | 1.59 | ◯ | ◯ |
| C. Ex. 3 | 1.82 | 1.75 | 1.60 | X | Δ |
| C. Ex. 4 | 1.82 | 1.71 | 1.60 | Δ | Δ |
| C. Ex. 5 | 1.80 | 1.69 | 1.59 | ◯ | ◯ |
| C. Ex. 6 | 1.75 | 1.62 | 1.52 | ◯ | ◯ |
| C. Ex. 7 | 1.79 | 1.66 | 1.55 | ◯ | ◯ |
| C. Ex. 8 | 1.79 | 1.64 | 1.55 | ◯ | ◯ |

As is clearly shown in Table 1 above, it is obvious that all of the ink jet recording sheets according to the present invention have an excellent and better print concentration property, etc., as compared with the recording sheets of Comparative Examples. Therefore, according to the present invention, it becomes possible to provide an ink jet recording sheet which has excellent recording property and print preservability for dye ink as well as pigment ink.

The ink jet recording sheet of the present invention which includes a supporting medium and an ink receiving layer disposed on the supporting medium may achieve its excellent recording properties due to the ink receiving layer which includes pigment, at least a styrene-acryl copolymer resin as an adhesive, and a guanidine compound and a secondary ammonium salt compound as a cationic polymer. Accordingly, the ink jet recording sheet of the present invention may be widely used in the field of, for example, high glossiness type, glossiness type, and mat type ink jet recording sheet; film based, RC paper based, and paper based ink jet recording sheet; non-transparent medium and transparent medium ink jet recording sheet; and so forth.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

1. Ink jet recording sheet, comprising:
a supporting medium; and
an ink receiving layer disposed on said supporting medium, said ink receiving layer including; pigment; at least a styrene-acryl copolymer resin as an adhesive; and a guanidine compound and a secondary ammonium salt compound as a cationic polymer.

2. The ink jet recording sheet according to claim 1, wherein at least a part of said pigment has a surface treated with a surfactant.

3. The ink jet recording sheet according to claim 2, wherein said pigment is silica.

4. The ink jet recording sheet according to claim 1, wherein a glass transition temperature of said styrene-acryl copolymer resin is within a range of −10 to 60° C.

5. The ink jet recording sheet according to claim 1, wherein said guanidine compound is a dicyandiamide-polyethylene amine copolymer.

6. The ink jet recording sheet according to claim 1, wherein said secondary ammonium salt compound is a compound having an acrylamide-diallyl amine structure.

7. Ink jet recording sheet, comprising:
a supporting medium; and
an ink receiving layer disposed on said supporting medium, said ink receiving layer including; pigment; at least a styrene-acryl copolymer resin as an adhesive; and a dicyandiamide-polyethylene amine copolymer and a compound having an acrylamide-diallyl amine structure as a cationic polymer.
